(19) United States
(12) Patent Application Publication
(10) Pub. No.: US 2016/0108296 A1
(43) Pub. Date: Apr. 21, 2016

(54) BONDING ADHESIVE AND ADHERED ROOFING SYSTEMS PREPARED USING THE SAME

(71) Applicant: FIRESTONE BUILDING PRODUCTS COMPANY, LLC, Indianapolis, IN (US)

(72) Inventor: Jiansheng TANG, Westfield, IN (US)

(21) Appl. No.: 14/895,095

(22) PCT Filed: Jul. 28, 2014
(86) PCT No.: PCT/US2014/048409

§ 371 Date: Dec. 1, 2015

Related U.S. Application Data
(60) Provisional application No. 61/858,715, filed on Jul. 26, 2013.
(60) Provisional application No. 61/934,045, filed on Jan. 31, 2014.

(51) Int. Cl. C09J 153/00; E04D 5/14

(52) U.S. Cl. CPC C09J 153/00; E04D 5/148

(57) ABSTRACT

A bond adhesive composition comprising an acrylic block copolymer and protic solvent.

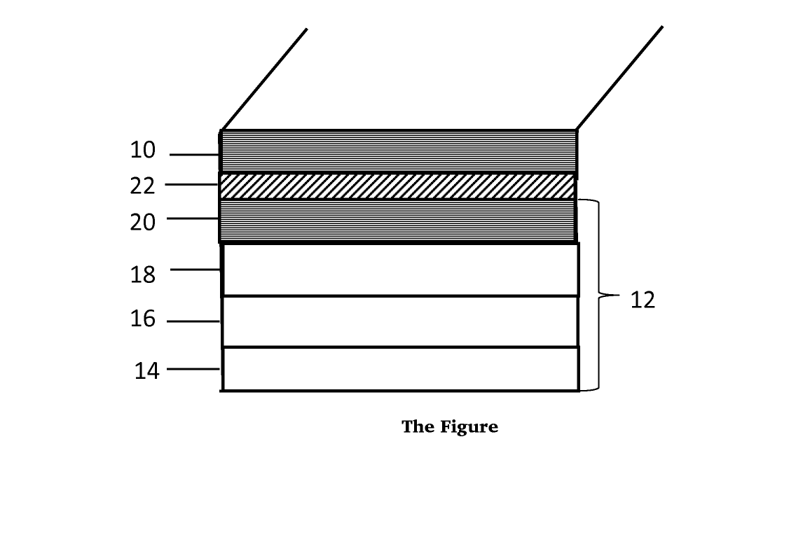

This application claims the benefit of U.S. Provisional Application Ser. Nos. 61/934,045, filed Jan. 31, 2014 and 61/858,715, filed Jul. 26, 2013, which are incorporated herein by reference.

### FIELD OF THE INVENTION

Embodiments in the invention are directed toward an acrylic block copolymer bonding adhesive and adhered roofing systems prepared with the adhesive.

### BACKGROUND OF THE INVENTION

Polymeric membranes, such as cured sheets of ethylene-propylene-diene copolymer rubber (EPDM) or extruded sheet of thermoplastic olefins (TPO), are often used in the construction industry to cover flat or low-sloped roofs. These membranes, which may also be referred to as panels, are typically delivered to a construction site in a bundled roll, transferred to the roof, and then unrolled and positioned. The sheets are then affixed to the building structure by employing varying techniques such as mechanical fastening, ballasting, and/or adhesively adhering the membrane to the roof. The roof substrate to which the membrane is secured may include a variety of materials depending on the situation. For example, the surface may be a concrete, metal, or wood deck, it may include insulation or recover board, and/or it may include an existing membrane.

In addition to securing the membrane to the roof—which mode of attachment primarily seeks to prevent wind uplift—the individual membrane panels, together with flashing and other accessories, are positioned and adjoined to achieve a waterproof barrier on the roof. Typically, the edges of adjoining panels are overlapped, and these overlapping portions are adjoined to one another through a number of methods depending upon the membrane materials and exterior conditions. One approach involves providing adhesives or adhesive tapes between the overlapping portions, thereby creating a water-resistant seal.

Thus, there are two modes of membrane attachment that are used in conjunction. The first seeks to anchor the membrane to the roof, while the second seeks to create a water-impervious barrier by attaching individual adjacent membrane panels to each other or to flashing. Inasmuch as these modes of membrane attachment seek entirely different goals, the mechanisms by which they operate are likewise distinct.

Adhesive attachment is typically employed to form adhered roofing systems. The membrane may be adhered to the roof substrate substantially across the entire planar surface of the membrane to form fully-adhered systems. In other words, a majority, if not all, of the membrane panel is secured to the roof substrate as opposed to mechanical attachment methods which can only achieve direct attachment in those locations where a mechanical fastener actually affixes the membrane. Fully-adhered roofing systems are advantageously installed where maximum wind uplift prevention is desired. Also, fully-adhered systems are desirable in re-roofing situations, especially where the new membrane is placed over an existing membrane (a technique that is commonly referred to as re-skinning).

Several techniques are employed to prepare fully-adhered roofing systems. One technique includes the use of a fleece-backed EPDM membrane that is secured to the substrate by using a low-rise polyurethane foam adhesive that is sprayed over the substrate. Once the adhesive polyurethane foam is applied, the fleece-backed membrane is applied to the adhesive layer, which attaches itself to the fleece backing. Alternatively, nitrile-based bond adhesives can be applied to the substrate and the fleece-backed EPDM membrane can be secured thereto. Because these systems require fleece-backed membranes, they are expensive and suffer from manufacturing inefficiencies relating to the need to secure the fleece to the membrane.

Other techniques employ a conventional EPDM membrane sheet, which is not modified with a fleece backing. In these situations, it is common to employ a contact bonding method whereby technicians coat both the membrane and the substrate that receives the membrane with an adhesive. The adhesive is then typically allowed to at least partially set to, among other things, build some wet green strength. The membrane is then mated with the substrate via the partially-set adhesive. Because the volatile components (e.g. solvent) of the adhesives are “flashed off” prior to mating, good, early (green) bond strength can advantageously be developed.

One technique employs a water-borne bond adhesive that is applied to the substrate and then the EPDM membrane can be applied to the adhesive layer. While this attachment technique has proven useful, the use is generally limited to ambient weather conditions (e.g. greater than 40° C.) and/or in conjunction with porous substrates that absorb water thereby allowing the adhesive to dry or cure without blistering the membrane.

In other situations, solvent-based adhesives are employed, such as polychloroprene-based bond adhesives. While the use of known solvent-based adhesives has proven versatile to the extent that the substrate need not be porous and cold-weather application is feasible, the technique requires application of the adhesive to both the substrate and the membrane, followed by a time delay to allow the solvent to flash off, and then a mating of the two adhesive surfaces (i.e., the adhesive coated membrane is mated to the adhesive coated membrane).

In yet other situations, 100% solids bond adhesives are employed. For example, U.S. Pat. No. 7,767,308 teaches a moisture-curable bond adhesive that includes a polymer or a combination of polymers having silicon-containing hydrolyzable terminal groups, a phenolic resin, and a non-polymeric silicon-containing hydrolyzable compound. While these bond adhesives are touted for being free of volatile organic compounds (VOCs), safe for chronic exposure, and non-flammable, and yet provide a high initial peel strength and/or high peel strength upon being fully cured between a roof substrate and a rubber membrane, it would nonetheless be desirable to formulate a bond adhesive that is does not include a phenolic resin.

While both solvent-based and water-based adhesives may be used as contact adhesives, solvent-based bonding adhesives offer advantages. For example, the flash-off period, which is the time required to allow solvent evaporation prior to mating, can be between 5 and 40 minutes, and is less susceptible to environmental conditions, such as temperature, than water-based adhesive systems. Current solvent-based adhesives possess wide application windows, appropriate drying performance and good bonding properties. However, they use a lot of VOC solvents to dissolve the polymers, usually rubber materials. As the industry moves towards “green” roofing, the VOC solvents in the bonding adhesives have to be replaced with non-VOC materials.
Current approaches to eliminate VOC solvents haven't created a solution that can provide the same applications and adhesion properties as the conventional solvent-based bonding adhesive can. Thus there is therefore a need in the art for a bond adhesive which uses acrylic block copolymers and a non-VOC-based solvents which provides the same applications and adhesion properties as the conventional solvent-based bonding adhesive.

### SUMMARY OF THE INVENTION

One or more embodiments of the present invention provide a bond adhesive composition comprising an acrylic block copolymer and protic solvent.

Still other embodiments of the present invention provide a method for forming an adhered membrane roof system, the method comprising applying a bond adhesive to a substrate on a roof to form an adhesive layer, where the bond adhesive includes an acrylic block copolymer and a polar solvent, allowing the polar solvent to at least evaporate to thereby form an adhesive layer, and applying a membrane directly to the adhesive layer.

### BRIEF DESCRIPTION OF THE DRAWINGS

The FIGURE is a cross sectional view of a roofing system including EPDM membrane adhered to a substrate using an adhesive according to one or more embodiments of the present invention.

### DETAILED DESCRIPTION OF ILLUSTRATIVE EMBODIMENTS

Embodiments of the invention are based, at least in part, on the discovery of a bond adhesive that includes an acrylic block copolymer. The bond adhesive compositions advantageously employ protic solvents, which are believed to have less environmental impact than highly volatile non-polar solvents employed in prior art bond adhesives. As a result, the bond adhesives of one or more embodiments can advantageously be used to bond the polymeric substrates (e.g. roofing membranes) to other substrates (e.g., isocyanate construction boards) while satisfying stringent environmental standards that are in place for these types of applications. Moreover, it has advantageously been discovered that the bond adhesives of one or more embodiments of the present invention can be used to prepare fully-adhered systems that advantageously meet FM 4470/4474 standards for wind uplift. And, it has been unexpectedly discovered that these adhered systems can be mated to a variety of substrates including existing membranes, which thereby provides a unique method for re-roofing or re-skinning an existing roof.

### Adhesive Composition

As discussed above, the adhesive compositions of this invention include an acrylic block copolymer. In addition, the adhesive compositions may include a hydrocarbon resin, a filler, a catalyst, an antioxidant, a stabilizer, a crosslink inhibitor (a.k.a retarder), and/or a thixotropic compound. In one or more embodiments, the adhesive composition employs one or more protic solvents, which may also be referred to as polar solvents. In particular embodiments, the composition is devoid of non-polar solvents.

### Acrylic Block Copolymer

In one or more embodiments, acrylic block copolymers include those polymers that include two or more blocks of different acrylic mer units. As used herein, the term acrylic mer units refers to those units that derive from acrylic or alkylacrylic (e.g., methacrylic) monomer. In one or more embodiments, the block copolymers include a first acrylic block that may be characterized as a soft block and a second acrylic block that may be characterized as a hard block.

In one or more embodiments, the acrylic mer units of the respective hard and soft blocks may be defined by the formula I:

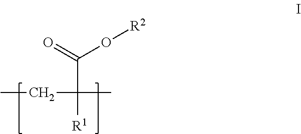

where R¹ is a hydrogen atom or a monovalent organic group and R² is a hydrogen atom or a monovalent organic group. In particular embodiments, R² is a monovalent organic group.

In one or more embodiments, the monovalent organic groups of the acrylic units may be hydrocarbyl groups such as, but not limited to, alkyl, cycloalkyl, alkenyl, cycloalkenyl, aryl, allyl, aralkyl, alkaryl, or alkynyl groups. Hydrocarbyl groups also include substituted hydrocarbyl groups, which refer to hydrocarbyl groups in which one or more hydrogen atoms have been replaced by a substituent such as a hydrocarbyl, hydrocarbyloxy, silyl, or silyloxy group. In one or more embodiments, these groups may include from one, or the appropriate minimum number of carbon atoms to form the group, to about 20 carbon atoms. These groups may also contain heteroatoms such as, but not limited to, nitrogen, boron, oxygen, silicon, sulfur, tin, and phosphorus atoms. In other embodiments, these groups are devoid of heteroatoms

In one or more embodiments, the soft acrylic blocks are synthesized from soft acrylic monomers, which include those monomers that upon polymerization (i.e. homopolymerization) give rise to elastomeric polymers. In one or more embodiments, the soft acrylic monomers, upon polymerization, give rise to polymers having a Tg below about 0° C., in other embodiments below about −20° C., and in still other embodiments below about −40° C.

In one or more embodiments, soft acrylic monomer include acrylates, which are monomer according to formula II:

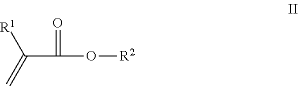

where R¹ is hydrogen and R² is a monovalent organic group. Examples of soft acrylic monomers include, but are not limited to, ethyl acrylate, propyl acrylate, isopropyl acrylate, n-butyl acrylate, 2-ethylhexyl acrylate, dodecyl acrylate, 2-methoxyethyl acrylate, n-hexyl methacrylate, 2-ethylhexyl methacrylate, and dodecyl methacrylate.

In one or more embodiments, hard acrylic blocks are synthesized from hard acrylic monomers, which include those monomers that upon polymerization (i.e. homopolymerization) give rise to thermoplastic polymers. In one or more embodiments, the hard acrylic monomers, upon polymerization, give rise to polymers having a Tg above about 0° C., in other embodiments above about 75° C., and in still other embodiments above about 100° C.

In one or more embodiments, hard acrylic monomer include alkylacrylates (e.g., methacrylates), which are monomer according to formula II above where R¹ is a monovalent organic group (e.g., alkyl group such as methyl group) and R² is a monovalent organic group. Examples of hard acrylic monomers include, but are not limited to, methyl methacrylate, ethyl methacrylate, n-propyl methacrylate, isopropyl methacrylate, n-butyl methacrylate, isobutyl methacrylate, sec-butyl methacrylate, tert-butyl methacrylate, cyclohexyl methacrylate, isobornyl methacrylate, phenyl methacrylate, benzyl methacrylate, phenoxyethyl methacrylate, 2-hydroxyethyl methacrylate, 2-methoxyethyl methacrylate, and methyl acrylate.

In one or more embodiments, the acrylic block copolymer may be an acrylic di-block copolymer represented by the formula: A-B, where A represents a hard acrylic block and B represents a soft acrylic block. In one or embodiments, the acrylic block copolymer may be an acrylic tri-block copolymer represented by the formula: A-B-A or B-A-B, where A represents a hard acrylic block and B represents a soft acrylic block. In one or embodiments, the acrylic block copolymer may be an acrylic tetra-block copolymer represented by the formula: A-B-A-B or B-A-B-A where A represents a hard acrylic block and B represents a soft acrylic block.

Specific examples of di-block acrylic block copolymers include [poly(n-butyl acrylate)]-[poly(methyl methacrylate)], and [poly(2-ethylhexyl acrylate)]-[poly(methyl methacrylate)].

Specific examples of tri-block acrylic block copolymers include [poly(methyl acrylate)]-[poly(n-butyl methacrylate)]-[poly(methyl acrylate)], [poly(methyl acrylate)]-[poly(2-ethylhexyl methacrylate)]-[poly(methyl acrylate)], [poly(methyl methacrylate)]-[poly(ethyl acrylate)]-[poly(methyl methacrylate)], [poly(methyl methacrylate)]-[poly(n-butyl acrylate)]-[poly(methyl methacrylate)], and [poly(methyl methacrylate)]-[poly(2-ethylhexyl acrylate)]-[poly(methyl methacrylate)].

The molecular weights of the polymer blocks in the acrylic block copolymer and the molecular weight of the whole acrylic block copolymer are not particularly limited. In one or more embodiments, the weight average molecular weight (Mw) of a hard acrylic block of the acrylic block copolymers may be from about 1,000 to about 400,000, in other embodiments from about 2,000 to about 300,000, and in other embodiments from about 10,000 to about 150,000 g/mole.

In one or more embodiments, the weight average molecular weight (Mw) of a soft acrylic block of the acrylic block copolymers may be from about 1,000 to about 400,000, in other embodiments from about 2,000 to about 300,000, and in other embodiments from about 10,000 to about 150,000 g/mole.

In one or more embodiments, the weight average molecular weight (Mw) of the whole acrylic block copolymers may be from about 5,000 to about 500,000, in other embodiments from about 10,000 to about 300,000, and in other embodiments from about 20,000 to about 150,000 g/mole.

The method for producing the acrylic block copolymer used in the present invention is not particularly limited, and the copolymer may be produced according to known methods. For example, a method of living polymerization of the monomers forming the polymer blocks is generally employed. Examples of the living polymerization method include anion polymerization using an organic alkali metal compound as a polymerization initiator in the presence of an alkali metal inorganic salt or an alkaline earth metal inorganic salt; anion polymerization using an organic alkali metal compound as a polymerization initiator in the presence of an organic aluminum compound; polymerization using an organic rare earth metal complex as a polymerization initiator; and radical polymerization using an α-halogenated ester compound as an initiator in the presence of a copper compound. Moreover, a method may be employed in which the monomers forming the polymer blocks are polymerized using a polyvalent radical polymerization initiator or a polyvalent radical chain transfer agent so that a mixture containing the acrylic block copolymer to be used in the present invention is prepared.

### Hydrocarbon Resin

As mentioned above, the adhesive composition may include one or more hydrocarbon resins. In one or more embodiments, the hydrocarbon resins may include natural resins, synthetic resins, and low molecular weight polymers or oligomers. The monomer that may be polymerized to synthesize the synthetic resins or low molecular weight polymers or oligomers may include those obtained from refinery streams containing mixtures or various unsaturated materials or from pure monomer feeds. The monomer may include aliphatic monomer, cycloaliphatic monomer, aromatic monomer, or mixtures thereof. Aliphatic monomer can include C₄, C₅, and C₆ paraffins, olefins, and conjugated diolefins. Examples of aliphatic monomer or cycloaliphatic monomer include butadiene, isobutylene, 1,3-pentadiene (piperylene) along with 1,4-pentadiene, cyclopentane, 1-pentene, 2-pentene, 2-methyl-1-pentene, 2-methyl-2-butene, 2-methyl-2-pentene, isoprene, cyclohexane, 1-3-hexadiene, 1-4-hexadiene, cyclopentadiene, and dicyclopentadiene. Aromatic monomer can include C₈, C₉, and C₁₀ aromatic monomer. Examples of aromatic monomer include styrene, indene, derivatives of styrene, derivatives of indene, and combinations thereof.

In one or more embodiments, examples of hydrocarbon resins include aliphatic hydrocarbon resins, at least partially hydrogenated aliphatic hydrocarbon resins, aliphatic/aromatic hydrocarbon resins, at least partially hydrogenated aliphatic aromatic hydrocarbon resins, cycloaliphatic hydrocarbon resins, at least partially hydrogenated cycloaliphatic resins, cycloaliphatic/aromatic hydrocarbon resins, at least partially hydrogenated cycloaliphatic/aromatic hydrocarbon resins, at least partially hydrogenated aromatic hydrocarbon resins, polyterpene resins, terpene-phenol resins, rosin esters, and mixtures of two or more thereof. In particular embodiments, a hydrogenated rosin ester is employed.

In certain embodiments, the synthetic aliphatic or aromatic hydrocarbon resins may be characterized by a number average molecular weight (Mₙ) of from about 400 g/mole to about 3,000 g/mole, and in other embodiments from about 500 g/mole to about 2,000 g/mole. These hydrocarbon resins may also be characterized by a weight average molecular weight (M_{W}) of from about 500 g/mole to about 6,000 g/mole, and in other embodiments from about 700 g/mole to about 5,000 g/mole. Molecular weight may be determined by size exclusion chromatography (SEC) by using a Waters 150 gel permeation chromatograph equipped with the differential refractive index detector and calibrated using polystyrene standards.

In certain embodiments, the hydrocarbon resins include those produced by thermal polymerization of dicyclopentadiene (DCPD) or substituted DCPD, which may further include aliphatic or aromatic monomers. In one embodiment, the DCPD or substituted DCPD is copolymerized with aromatic monomer, and the final product includes less than 10% aromatic content. In another embodiment, the hydrocarbon resin derives from the copolymerization of both aliphatic monomer and aromatic monomer. In particular embodiments, the dicyclopentadiene tackifier resin is hydrogenated. Hydrogenated dicyclopentadiene tackifier resins are commercially available from Neville.

In one or more embodiments, synthetic oligomers may include dimers, trimers, tetramers, pentamers, hexamers, septamers, and octamers of petroleum distillate monomer. In one or more embodiments, this petroleum distillate monomer may have a boiling point of from about 30° to about 210° C. The oligomers may include byproducts of resin polymerization including thermal and catalytic polymerization. For example, oligomers may derive from processes where DCPD, aliphatic monomer, and/or aromatic monomer are oligomerized.

The hydrocarbon resins may be characterized by an aromatic content of from about 1 to about 60, in other embodiments from about 2 to about 40, and in other embodiments from about 5 to about 10. In one or more embodiments, the tackifier resins are hydrogenated or partially hydrogenated; useful resins include those that are at least 50 percent, in other embodiments at least 80 percent, in other embodiments at least 95 percent, and in other embodiments at least 99 percent or fully hydrogenated. For example, the hydrocarbon resin prior to grafting may contain less than 90, in other embodiments less than 50, in other embodiments less than 25, in other embodiments less than 10, in other embodiments less than 2, in other embodiments less than 1, in other embodiments less than 0.5, and in other embodiments less than 0.05 olefinic protons. Aromatic content and olefin content may be measured by ¹H-NMR as measured directly from the ¹H NMR spectrum from a spectrometer with a field strength greater than 300 MHz, and in other embodiments 400 MHz (frequency equivalent). Aromatic content includes the integration of aromatic protons versus the total number of protons. Olefin proton or olefinic proton content includes the integration of olefinic protons versus the total number of protons.

In one or more embodiments, the hydrocarbon resin may be characterized by a softening point of from about 15° C. to about 210° C., in other embodiments from about 35° C. to about 180° C., in other embodiments from about 65° C. to about 170° C., in other embodiments from about 60° C. to about 150° C., and in other embodiments from about 90° C. to about 140° C. Softening point can be determined according to ASTM E-28 (Revision 1996).

In these or other embodiments, the hydrocarbon resin may be characterized by a glass transition temperature of less than 160° C., in other embodiments less than 120° C., in other embodiments less than 110° C., in other embodiments from about 10° C. to about 90° C., and in other embodiment from about 60° C. to about 80° C. Glass transition temperature may be determined according to ASTM D 341-88 by using differential scanning calorimetry.

In these or other embodiments, the hydrocarbon resin may be characterized by a Saponification number (mg KOH/g resin material) of greater than 10, in other embodiments greater than 15, and in other embodiments greater than 19.

In these or other embodiments, the hydrocarbon resin may be characterized by an acid number greater than 10, in other embodiments greater than 15, and in other embodiments greater than 20, and in other embodiments greater than 25.

### Plasticizers

In one or more embodiments, plasticizers that may optionally be employed in the adhesive compositions of this invention. In one or more embodiments, plasticizers include propylene glycol dibenzoate, diisononyl phthalate, and soy methyl esters, Mesamol II, HB-40, butylbenzylphthalate. In one or more embodiments, the plasticizers may include high boiling solvents that promote tackification, lowering of viscosity, and sprayability.

### Antioxidants

Antioxidants that may be employed if desired. Examples of useful antioxidants include hindered phenols and phosphate esters.

### Fillers

Generally, any compatible filler, such as calcium carbonate may be employed if desired for a particular application. As the skilled person will appreciate, fillers will generally be omitted when the adhesive composition is intended to be sprayed onto one surface that is subsequently applied to a second surface on which the adhesive is or is not deposited.

### Protic Solvent

In one or more embodiments, the adhesive composition of the present invention includes a protic solvent. Examples of protic solvents include aliphatic ketones such as methyl propyl ketone (MPK) and acetone, alkyl acetates such as methyl acetate, ethyl acetate, propyl acetate, and n-butyl acetate, and t-butyl acetate, alkanes other than hexane such as heptane, octane, nonane, decane, and higher alkanes which can be branched, cyclic, or straight chain, ethers such as ethyl ether and methyl ethyl ether, and halogenated hydrocarbons such as n-propyl bromide. In general, the solvents have from 4 to 20 carbon atoms. In particular embodiments, the solvent is devoid of methyl ethyl ketone. In one or more embodiments, the solvent or solvent blend employed is exempt under Federal VOC standards. In particular embodiments, a blend of t-butyl acetate and acetone is employed.

### Amounts

Acrylic Block Copolymer

In one or more embodiments, the adhesive compositions of the invention include at least 3, in other embodiments at least 5, in other embodiments at least 7, and in other embodiments at least 10 wt. % acrylic block copolymer, based on the entire weight of the composition. In these or other embodiments, the adhesive compositions of the invention include at most 75, in other embodiments at most 65, in other embodiments at most 55, in other embodiments at most 50, in other embodiments at most 40, and in other embodiments at most 30 wt. % acrylic block copolymer, based on the entire weight of the composition. In one or more embodiments, the adhesive compositions of the invention include from about 3 to about 50, in other embodiments from about 5 to about 75, in other embodiments from about 7 to about 65, in other embodiments from about 5 to about 40, in other embodiments from about 10 to about 30, and in other embodiments from about 10 to about 55 wt. % acrylic block copolymer, based on the entire weight of the composition.

Hydrocarbon Resin

In one or more embodiments, the adhesive compositions of the invention include at least 0.1, in other embodiments at least 0.3, in other embodiments at least 0.5, in other embodiments at least 1, in other embodiments at least 2, and in other embodiments at least 3 wt. % hydrocarbon, based on the entire weight of the composition. In these or other embodiments, the adhesive compositions of the invention include at most 20, in other embodiments at most 18, in other embodiments at most 15, in other embodiments at most 8, in other embodiments at most 7, and in other embodiments at most 6 wt. % hydrocarbon, based on the entire weight of the composition. In one or more embodiments, the adhesive compositions of the invention include from about 0.1 to about 8, in other embodiments from about 0.3 to about 7, in other embodiments from about 0.5 to about 6, in other embodiments from about 1 to about 20, in other embodiments from about 2 to about 18, and in other embodiments from about 3 to about 15 wt. % hydrocarbon, based on the entire weight of the composition.

Hydrogenated Rosin Ester

In one or more embodiments, the adhesive compositions of the invention include at least 0.1, in other embodiments at least 0.3, in other embodiments at least 0.5, in other embodiments at least 1, in other embodiments least 2, and in other embodiments at least 3 wt. % hydrogenated rosin ester, based on the entire weight of the composition. In these or other embodiments, the adhesive compositions of the invention include at most 8, in other embodiments at most 7, in other embodiments at most 6, in other embodiments at most 15, in other embodiments at most 18, and in other embodiments at most 20 wt. % hydrogenated rosin ester, based on the entire weight of the composition. In one or more embodiments, the adhesive compositions of the invention include from about 0.1 to about 8, in other embodiments from about 0.3 to about 7, in other embodiments from about 0.5 to about 6, in other embodiments from about 1 to about 20, in other embodiments from about 2 to about 18, and in other embodiments from about 3 to about 15 wt. % hydrogenated rosin ester, based on the entire weight of the composition.

Fillers

In one or more embodiments, the adhesive compositions of the invention include at least 0, in other embodiments at least 0.3, and in other embodiments at least 0.6 wt. % filler, based on the entire weight of the composition. In these or other embodiments, the adhesive compositions of the invention include at most 18, in other embodiments at most 16, in other embodiments at most 14, in other embodiments at most 8, in other embodiments at most 6, and in other embodiments at most 4 wt. % filler, based on the entire weight of the composition. In one or more embodiments, the adhesive compositions of the invention include from about 0 to about 8, in other embodiments from about 0.3 to about 6, in other embodiments from about 0.6 to about 4, in other embodiments from about 0 to about 18, in other embodiments from about 0.3 to about 16, and in other embodiments from about 0.6 to about 14 wt. % filler, based on the entire weight of the composition.

Antioxidants

In one or more embodiments, the adhesive compositions of the invention include at least 0.05, in other embodiments at least 0.07, and in other embodiments at least 0.10 wt. % antioxidant, based on the entire weight of the composition. In these or other embodiments, the adhesive compositions of the invention include at most 3, in other embodiments at most 2, and in other embodiments at most 1 wt. % antioxidant, based on the entire weight of the composition. In one or more embodiments, the adhesive compositions of the invention include from about 0.05 to about 3, in other embodiments from about 0.07 to about 2, and in other embodiments from about 0.1 to about 1 wt. % antioxidant, based on the entire weight of the composition.

Plasticizer

In one or more embodiments, the adhesive compositions of the invention include at least 0, in other embodiments at least 0.5, and in other embodiments at least 1 wt. % plasticizer, based on the entire weight of the composition. In these or other embodiments, the adhesive compositions of the invention include at most 15, in other embodiments at most 10, in other embodiments at most 8, in other embodiments at most 5, in other embodiments at most 4, and in other embodiments at most 3 wt. % plasticizer, based on the entire weight of the composition. In one or more embodiments, the adhesive compositions of the invention include from about 0 to about 5, in other embodiments from about 0.5 to about 2, in other embodiments from about 1 to about 3, in other embodiments from about 0 to about 15, in other embodiments from about 0.5 to about 10, and in other embodiments from about 1 to about 3 wt. % plasticizer, based on the entire weight of the composition.

Protic Solvent

As discussed above, the adhesive compositions of the invention include at least 15, in other embodiments at least 25, in other embodiments at least 35, in other embodiments at least 45, in other embodiments at least 50, and in other embodiments at least 55 wt. % protic solvent, based on the entire weight of the composition. In these or other embodiments, the adhesive compositions of the invention include at most 90, in other embodiments at most 80, and in other embodiments at most 70 wt. % protic solvent, based on the entire weight of the composition. In one or more embodiments, the adhesive compositions of the invention include from about 45 to about 90, in other embodiments from about 50 to about 80, in other embodiments from about 55 to about 70, in other embodiments from about 15 to about 90, in other embodiments from about 25 to about 80, and in other embodiments from about 35 to about 70 wt. % protic solvent, based on the entire weight of the composition.

Phenolic Resin

In one or more embodiments, the adhesive compositions of the invention include at least 0.1, in other embodiments at least 0.3, in other embodiments at least 0.5, in other embodiments at least 1, in other embodiments at least 2, and in other embodiments at least 3 wt. % phenolic resin, based on the entire weight of the composition. In these or other embodiments, the adhesive compositions of the invention include at most 20, in other embodiments at most 18, in other embodiments at most 15, in other embodiments at most 8, in other embodiments at most 7, and in other embodiments at most 6 wt. % phenolic resin, based on the entire weight of the composition. In one or more embodiments, the adhesive compositions of the invention include from about 0.1 to about 8, in other embodiments from about 0.3 to about 7, in other embodiments from about 0.5 to about 6, in other embodiments from about 1 to about 20, in other embodiments from about 2 to about 18, and in other embodiments from about 3 to about 15 wt. % phenolic resin, based on the entire weight of the composition

In other embodiments, the adhesive compositions of the invention may be devoid or substantially devoid of phenolic resin. In one or more embodiments, the compositions may be devoid of phenolic resin. In these or other embodiments, the adhesive compositions are substantially devoid of phenolic resin, which refers to that amount of solvent or less that will not have an appreciable impact on the composition. In one or more embodiments, the compositions of this invention include less than 0.5, in other embodiments less than 0.3, and in other embodiments less than 0.2 wt. % phenolic resin.

### Preparation of Adhesive

The adhesive compositions of the present invention may be prepared by batch mixing using conventional batch mixing equipment. In one or more embodiments, the mixer may be equipped with an emulsifier. The mixing can take place under atmospheric pressure and at room temperature. The ingredients can conveniently be introduced to the mixer by first introducing the acrylic block copolymer followed by introduction of the other ingredients. Mixing may continue until desired viscosity or level of dispersion/solubility is achieved. In particular embodiments, mixing is conducted for at least 60 minutes, in other embodiments at least 80 minutes, in other embodiments at least 100 minutes, in other embodiments at least 120 minutes, in other embodiments at least 150 minutes, in other embodiments at least 180 minutes, and in other embodiments at least 190 minutes. In particular embodiments, mixing is continued until a viscosity of less than 4200 cps, in other embodiments less than 4000 cps, and in other embodiments less than 3800 cps is achieved (#3 spindle @ 71° F.-73° F.). In these or other embodiments, mixing is continued until a viscosity of at least 3000 cps, in other embodiments at least 3200 cps, and in other embodiments at least 3300 cps is achieved (#3 spindle @ 71° F.-73° F.).

### Characteristics of Adhesive Composition

In one more embodiments, the adhesive composition is formulated to offer various characteristics that are advantageous in practicing the present invention.

In one or more embodiments, the adhesive composition can be formulated to achieve advantageous green strength after a short amount of solvent flash off time. For example, the compositions of one or more embodiments demonstrate, at a wet film thickness from about 5 to about 40 mils, a green strength of at least 0.3 pli, in other embodiments at least 0.5 pli, and in other embodiments at least 0.7 pli within a 2 minute flash off period.

The adhesive compositions of one or more embodiments, when used to bond EPDM rubber sheet material to a high density particleboard, exhibit a peel strength of at least 2.5-4 (or in other embodiments at least 2.0) pounds per linear inch (pli) after 30 day ambient cure. Moreover, the adhesion strength in these compositions substantially improve with time and temperature. In one or more embodiments, after 30 days aging at 150° F. (normal rooftop conditions) peel strengths as high as 7.8 pli can be obtained.

### INDUSTRIAL APPLICABILITY

In one or more embodiments, the adhesive composition of the present invention may be employed as a contact adhesive in roofing applications. In particular embodiments, the contact adhesive may be employed to fully secure a membrane panel to a substrate on a roof deck. In particular embodiments, the adhesive may be employed in preparing a fully-adhered roofing membrane system. In other embodiments, the contact adhesive may be used for securing membrane panel or flashing to vertical surfaces within a roofing system.

Practice of the present invention is not necessarily limited by the selection of a particular roofing membrane that is secured to a substrate on a roof surface. As is known in the art, numerous roofing membranes have been proposed in the art and several are used commercially including thermoset and thermoplastic roofing membranes. Commercially available thermoplastic roofing membranes may include polyvinyl chloride or polyolefin copolymers. For example, thermoplastic olefin (TPO) membranes are available under the trade names UltraPly™, and ReflexEON™ (Firestone Building Products). Commercially available thermoset roofing membranes may include elastomeric copolymers such as ethylene-propylene-diene copolymer (EPDM) rubber and functionalized olefins such as chlorosulfonated polyethylene (CSPE). For example, EPDM membranes are available under the trade name RubberGard™, RubberGard Platinum™, RubberGard EcoWhite™, and RubberGard MAX™ (Firestone Building Products). Useful EPDM membrane is disclosed in, for example, U.S. Pat. Nos. 7,175,732, 6,502,360, 6,120,869, 5,849,133, 5,389,715, 4,810,565, 4,778,852, 4,732,925, and 4,657,958, which are incorporated herein by reference. EPDM membranes are commercially available from a number of sources; examples include those available under the tradenames RubberGard (Firestone Building Products) and SURE-SEAL (Carlisle SynTec).

In particular embodiments, EPDM membranes are employed. As is known in the art, EPDM membrane panels include vulcanized or cured rubber compositions. These compositions may include, in addition to the rubber that is ultimately vulcanized, fillers, processing oils, and other desired ingredients such as plasticizers, antidegradants, adhesive-enhancing promoters, etc., as well as vulcanizing agents such as sulfur or sulfur-donating compounds.

In one or more embodiments, the EPDM roofing panels have a thickness in accordance with ASTM D-4637-04. In one or more embodiments, the EPDM roofing panels have a thickness of at least 45 mil±10%, in other embodiments at least 60 mil±10%, and in other embodiments at least 90 mil±10%. In these or other embodiments, the EPDM roofing panels may have a thickness of less than 65 mil±10%, in other embodiments less than 80 mil±10%, and in other embodiments less than 110 mil±10%.

In one or more embodiments, the bonding adhesive may be applied to at least a portion of a membrane panel or flashing to form a wet film of the composition on at least a portion of the membrane. In preparing a fully-adhered system, substantially one side of the membrane panel is coated with the composition to form a wet film over a substantial portion of the membrane.

In one or more embodiments, the substrate to which the membrane panel or flashing is ultimately attached is likewise provided with a film of the adhesive compositions. In other words, the adhesive composition is applied to at least a portion of the substrate. In other embodiments, the adhesive is applied exclusively to the membrane.

In other embodiments, the bond adhesive composition of the present invention is applied exclusively to the substrate (e.g. the roof or materials on the roof such as insulation board), and the membrane is subsequently positioned over the adhesive layer without application of the adhesive directly to the membrane.

### Application Method

In one or more embodiments of this invention, an adhered roofing system is constructed by applying the adhesive composition to a roof substrate to form a layer of adhesive and then subsequently contacting a surface of an EPDM panel to the layer of adhesive disposed on the substrate. Advantageously, the process can be used to construct a roofing system meeting the standards of UL and Factory Mutual for wind uplift without the need for applying an adhesive directly to the EPDM panel being installed. Moreover, these standards can be met in the absence of a fleece or other backing material applied to the membrane.

The substrate to which the adhesive composition is applied may include a roof deck, which may include steel, concrete, and/or wood. In other embodiments, the adhesive composition may be applied to insulation materials, such as insulation boards and cover boards. As those skilled in the art appreciate, insulation boards and cover boards may carry a variety of facer materials including, but not limited to, paper facers, fiberglass-reinforced paper facers, fiberglass facers, coated fiberglass facers, metal facers such as aluminum facers, and solid facers such as wood, OSB and plywood, as well as gypsum. In yet other embodiments, the adhesive composition may be applied to existing membranes. These existing membranes may include cured rubber systems such as EPDM membranes or chlorosulfonated polyethylene, thermoplastic polymers systems such as TPO membranes or PVC membranes, or asphalt-based systems such as modified asphalt membranes and/or built roof systems. Advantageously, practice of the present invention provides adhesion to asphalt-based substrates by offering sufficient oil resistance, which is required to maintain sufficient adhesion to asphalt systems.

In one or more embodiments, the adhesive composition is applied to the substrate by dip and roll techniques, which are conventional in the art of applying adhesives to substrates and/or membrane panels. In other embodiments, the adhesive composition is applied to the substrate by spraying. In one or more embodiments, the spraying may be accomplished by using airless spray equipment or air-assisted spray equipment. In one or more embodiments, the adhesive composition is atomized during the spraying operation. Useful spraying equipment is known in the art, such as the spray equipment available from Graco and Garlock. In other embodiments, the adhesive can be applied by a power roller, where the adhesive is pumped to the roller head. Examples include power rollers as supplied by Garlock. In yet other embodiments, the adhesive can be applied by using a drop spreader, which generally includes gravity feeding of the adhesive from a mobile platform such as that sold under the tradename BetterSpreader (Roofmaster).

In one or more embodiments, time is permitted between the application of the adhesive composition and application of the EPDM panel. In one or more embodiments, this time provided is less than 1 hour, in other embodiments less than 30 minutes, in other embodiments less than 10 minutes, and in other embodiments less than 3 minutes. In one or more embodiments, the time provided is from 1 minute to 1 hour.

In one or more embodiments, the wet film applied to the membrane and/or the substrate can be at least 4 mils, in other embodiments at least 5 mils, in other embodiments at least 6 mils, in other embodiments at least 6.5 mils, in other embodiments at least 7 mils, in other embodiments at least 10 mils, in other embodiments at least 13 mils, and in other embodiments at least 15 mils thick (wet film thickness). In these or other embodiments, the wet film thickness on each of the respective layers may be less than 40 mils, in other embodiments less than 30 mils, in other embodiments less than 25 mils, in other embodiments less than 20 mils, in other embodiments less than 18 mils, and in other embodiments less than 15 mils thick (wet film thickness). It has advantageously been discovered that practice of the present invention allows for application of a thinner wet film than has been previously employed using conventional bond adhesives while achieving technologically useful bond adhesion. As a result, during use of the bond adhesive, the application rate can be reduced (i.e., less bond adhesive is needed per square foot, which translates into an increased application rate). For example, in one or more embodiments, technologically useful adhesion can be achieved at application rates of at least 50 square foot per gallon, in other embodiments at least 60 square foot per gallon, in other embodiments at least 70 square foot per gallon, in other embodiments at least 80 square foot per gallon, in other embodiments at least 90 square foot per gallon, and in other embodiments at least 100 square foot per gallon.

In one or more embodiments, the application of the adhesive composition is applied to the substrate in an amount sufficient to form a dried layer having a dry-film thickness of from about 3 to about 20 mils, in other embodiments from about 5 to about 15 mils, in other embodiments from about 7 to about 12 mils, in other embodiments from about 4 to about 15 mils, ad in other embodiments from about 4.5 to about 12 mils.

In one or more embodiments, the EPDM panel may be applied to the adhesive layer using several known techniques. For example, the EPDM panel may be unrolled on to the adhesive layer.

### Roof Construction

Aspects of the invention may be understood with reference to the FIGURE, which shows membrane 10 adhered to substrate 12. The substrate may include one or more of a roof deck 14, an insulation layer 16, a coverboard 18, and an existing membrane 20. In other words, membrane 10 may be adhered to roof deck 14, insulation layer 16, coverboard 18, or existing membrane 20. Disposed between an adhering membrane 10 to substrate 12 is a layer 22 of adhesive, which layer may be continuous or substantially continuous between membrane 10 and substrate 12 (i.e. a fully-adhered system). In one or more embodiments, the adhesive layer covers at least 20%, in other embodiments at least 30%, in other embodiments at least 40%, in other embodiments at least 50%, and in other embodiments at least 60% of the surface of the substrate. In these or other embodiments, the adhesive layer covers less than 95%, in other embodiments less than 90%, in other embodiments less than 85%, in other embodiments less than 75%, and in other embodiments less than 60% of the surface of the substrate. Notably absent from the construction of one or more embodiments is a fleece layer between membrane 10 and substrate 12. In other words, adhesive layer 22 is adhesively bonded directly to membrane 10.

In one or more embodiments, the bond between substrate 12 and membrane 10, which is formed by adhesive layer 22, can be quantified based upon standardized peel adhesion tests pursuant to ASTM D1876. In one or more embodiments, the bond between membrane 10 and substrate 12 exceeds at least 1 pli, in other embodiments at least 1.5 pli, in other embodiments at least 2 pli, and in other embodiments at least 2.5 pli. Advantageously, in one or more embodiments, the bond formed between membrane 10 and substrate 12 exceeds the pull strength limitations and/or tensile limitations of the substrate. In other words, the substrate fails under pull force (for example the facer pulls from the insulation or substate boards) prior to the failure of adhesive layer 22.

Various modifications and alterations that do not depart from the scope and spirit of this invention will become apparent to those skilled in the art. This invention is not to be duly limited to the illustrative embodiments set forth herein.

What is claimed is:

1. A bond adhesive composition comprising:
i. an acrylic block copolymer; and
ii. protic solvent.

2. The composition of claim 1, where the composition further includes a hydrocarbon resin.

3. The composition of claim 1, where the protic solvent is selected from the group consisting of aliphatic ketones such as methyl propyl ketone (MPK) and acetone, alkyl acetates such as methyl acetate, ethyl acetate, propyl acetate, and n-butyl acetate, and t-butyl acetate, alkanes other than hexane such as heptane, octane, nonane, decane, and higher alkanes which can be branched, cyclic, or straight chain, ethers such as ethyl ether and methyl ethyl ether, and halogenated hydrocarbons such as n-propyl bromide.

4. The composition of claim 1, where the composition includes from about 3 to about 75 wt. % of the acrylic block copolymer, and from about 15 to about 90 wt. % protic solvent, based on the total weight of the composition.

5. The composition of claim 1, where the hydrocarbon resin is selected from the group consisting of natural resins, synthetic resins, and low molecular weight polymers or oligomers.

6. The composition of claim 5, where the composition includes from about 1.0 to about 20 wt. % hydrocarbon resin.

7. A method for forming an adhered membrane roof system, the method comprising:
i. applying a bond adhesive to a substrate on a roof to form an adhesive layer, where the bond adhesive includes an acrylic block copolymer and a polar solvent;
ii. allowing the polar solvent to at least evaporate to thereby form an adhesive layer; and
iii. applying a membrane directly to the adhesive layer.

8. The method of claim 7, where the adhesive forms a substantially continuous layer between the substrate and the membrane over at least 40% of the entire roof surface.

9. The method of claim 7, where the method is devoid of any step of applying the adhesive directly to the rubber membrane.

10. The method of claim 7, where said step of applying the adhesive includes dip and roll techniques.

11. The method of claim 7, where said step of applying the adhesive includes spraying the adhesive on the substrate.

12. The method of claim 7, where the substrate includes an insulation board.

13. The method of claim 7, where the substrate includes a coverboard.

14. The method of claim 7, where the substrate includes an existing membrane.

15. The method of claim 7, where the existing membrane is a roofing membrane.

16. The method of claim 7, where the existing membrane includes an asphalt-based roofing membrane.

17. The method of claim 7, where said step of applying a membrane includes applying an EPDM membrane.

18. The method of claim 7, where the membrane is a rubber-based membrane.

19. The method of claim 7, where the membrane is a thermoplastic-based membrane.
